(19) United States
(12) Patent Application Publication
(10) Pub. No.: US 2024/0138618 A1
(43) Pub. Date: May 2, 2024

(54) COOKING STATION WITH HEAT SHIELD AND VENTING, SYSTEM, AND METHOD THEREOF

(71) Applicant: North Atlantic Imports, LLC, Logan, UT (US)

(72) Inventors: Jared M. Smith, Paradise, UT (US); Adam S. Dexter, Wellsville, UT (US)

(21) Appl. No.: 18/385,374

(22) Filed: Oct. 30, 2023

Related U.S. Application Data
(60) Provisional application No. 63/421,890, filed on Nov. 2, 2022.

(51) Int. Cl. A47J 37/07

(52) U.S. Cl. CPC A47J 37/0704; A47J 37/0786

(57) ABSTRACT

A cooking system for minimizing heat therein. The cooking system includes a main body extending to define a fire box with gas flame burners coupled thereto. The main body sized to support a griddle thereon so as to be positioned over the gas flame burners. The fire box including a heat shield positioned therein to define a gap between the heat shield and a rear panel and left and right panels. The gap also defined with a floor panel with lower panel openings defined therein. With this arrangement, upon the griddle being heated, air is drawn through the lower panel openings and into the gap and then through outer vents defined in the rear, left and right panels.

### CROSS-REFERENCE TO RELATED APPLICATIONS

This application claims the benefit of U.S. Provisional Application No. 63/421,890, filed Nov. 2, 2022, the disclosure of which is hereby incorporated by reference herein in its entirety.

### TECHNICAL FIELD

The present invention relates generally to outdoor cooking stations or systems and, more specifically, the present invention relates to shielding and redirecting heat produced by an outdoor cooking station or system.

### BACKGROUND

Outdoor cooking has become a favorite pass time for many as it can be utilized in multiple settings such as backyards, parks, camping, and tailgating. One problem that has surfaced with certain types of griddle cooking stations is that the exterior of the main body of the cooking station, or portions of the cooking station that support the griddle, can get hot and potentially result in the user or others in close proximity to the cooking station to accidentally touch the exterior and potentially getting burnt.

### BRIEF SUMMARY OF THE INVENTION

The present invention is directed to various embodiments configured to minimize heating portions of a cooking system or cooking station. In one embodiment, the cooking system includes a cooking station, an inner wall and a gap. The cooking station extends to define a front panel, a rear panel, a left panel, and a right panel. The front panel, the rear panel, the left panel, and the right panel extending to define an inner portion of the cooking station. The inner portion contains heating elements sized and configured to heat a griddle associated with the cooking station. The inner wall is positioned within the inner portion of the cooking station and extends parallel relative to the rear panel, the left panel, and the right panel of the cooking station such that the inner wall includes inner vents defined therein. The rear panel, the left panel, and the right panel includes outer vents defined therein. The gap is defined between the inner wall and each of the rear panel, the left panel, and the right panel. Further, the gap defines a floor panel, the floor panel including elongated openings defined therein. With this arrangement, the elongated openings are sized and configured to draw air into the gap and through the inner vents extending from the gap into the inner portion of the cooking station, and to draw air into the gap and through the outer vents extending from the gap to an exterior of the cooking station.

In another embodiment, the inner wall and the gap are sized and configured to minimize heating of the rear panel, the left panel, and the right panel. In another embodiment, the inner vents include inner vent blocking structure positioned to block direct line radiation heat of the heating elements from passing through a vent opening of the inner vents. In a further embodiment, the vent opening of the inner vent blocking structure extends upward. In still another embodiment, the vent opening of the inner vent blocking structure is at least partially defined by the inner vent blocking structure. In another embodiment, the outer vents include outer vent blocking structure positioned to block moisture from moving therethrough such that the outer vent blocking structure extends downward. In another embodiment, the cooking station includes a lower panel positioned below the heating elements, the lower panel having vents defined therein, the vents positioned to draw air into the inner portion of the cooking station to feed oxygen to the heating elements.

In yet another embodiment, upon heating the griddle, heat moves along an underside of the griddle to facilitate drawing air to flow through the openings, through the gap, and through the inner and outer vents. In another embodiment, the griddle includes an understructure positioned along an underside of the griddle and, upon the griddle being positioned on the cooking station and being heated by the heating elements, the understructure is configured to funnel heat rearward from the griddle and the cooking station. In another embodiment, upon the griddle being positioned on the cooking station and being heated by the cooking station, heat funnels substantially to a single side of the griddle and from the cooking station.

In accordance with another embodiment of the present invention, a cooking station is configured to minimize heating portions thereof. The cooking station includes a main body, a heat shield, and a griddle. The main body includes a front panel, a rear panel, a left panel and a right panel each extending to define an inner portion such that the inner portion is configured to hold heating elements positioned therein. The rear panel, the left panel and the right panel each define outer vents therein. The heat shield is positioned within the inner portion of the main body such that the heat shield extends with a rear heat shield, a left heat shield, and a right heat shield each positioned to be substantially parallel with the rear panel, the left panel and the right panel, respectively, so as to define a gap therebetween. The gap defines a floor panel with floor vents defined therein. The griddle is configured to be positioned over the heating elements and supported by the main body. With this arrangement, upon the griddle being heated by the heating elements, air is drawn through the floor vents into the gap and flows through the outer vents defined in each of the rear panel, the left panel and the right panel.

In another embodiment, the heat shield includes inner vents defined therein, the inner vents configured to facilitate air flow therethrough from the gap to the inner portion of the main body with the heating elements. In another embodiment, the inner vents include inner vent blocking structure positioned to block direct line radiation heat of the heating elements from passing through a vent opening of the inner vents. In another embodiment, the inner vent blocking structure extends upward. In still another embodiment, the outer vents include outer vent blocking structure positioned to block moisture from moving therethrough such that the outer vent blocking structure extends downward. In yet another embodiment, the heat shield and the gap are sized and configured to minimize heating of the rear panel, the left panel and the right panel. In another embodiment, the floor panel extends between each of the front panel, the rear panel, the left panel and the right panel so as to extend below each of the heating elements and at least partially define the gap, the floor panel including vent structure positioned below the heating elements and configured to draw air toward the heating elements to feed oxygen to the heating elements.

In accordance with another embodiment of the present invention, a method for minimizing heat in a cooking system is provided. The method includes: providing a main body of a cooking station with a front panel, a rear panel, a left panel and a right panel each extending to surround an inner portion of the main body, the inner portion containing heating elements positioned therein, and the rear panel, the left panel, and the right panel each defining outer vents therein, the main body including a heat shield positioned within the inner portion of the main body, the heat shield extending with a rear heat shield, a left heat shield, and a right heat shield each positioned to be substantially parallel with the rear panel, the left panel and the right panel, respectively, so as to define a gap therebetween, the gap defining a floor panel with floor vents defined therein; heating a griddle positioned on the main body above the heating elements; and drawing air through the floor vents into the gap to flow through the outer vents defined in each of the rear panel, the left panel and the right panel so as to minimize a temperature of portions of an exterior surface of the main body.

In another embodiment, the step of drawing includes moving air from the gap and through inner vents defined in the heat shield to move air into the inner portion with the heating elements. In another embodiment, the method further includes blocking direct line radiation heat from the heating elements with inner vent blocking structure from passing through a vent opening of the inner vents. In another embodiment, the step of heating the griddle includes substantially funneling most of the heat from a single side of the griddle and main body of the cooking station.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a perspective view of a cooking station, according to an embodiment of the present invention;

FIG. 2 is a partially exploded view of the cooking station, according to another embodiment of the present invention;

FIG. 3. is a cross-sectional view of the cooking station taken along section line 3-3 in FIG. 1, according to another embodiment of the present invention;

FIG. 4 is a cross-sectional view of the cooking station taken along section line 4-4 in FIG. 1, according to another embodiment of the present invention;

FIG. 5 is a partially exploded underside view of the cooking station, according to another embodiment of the present invention;

FIG. 6 is a cross-sectional view of the cooking station taken along section line 6-6 in FIG. 1, according to another embodiment of the present invention;

FIG. 6A is an enlarged view of a portion of the cooking station taken from region A in FIG. 6, according to another embodiment of the present invention;

FIG. 7 is a cross-sectional view of the cooking station taken along section line 4-4 in FIG. 1, according to another embodiment of the present invention;

FIG. 7A is an enlarged view of a portion of the cooking station taken from region B in FIG. 7, according to another embodiment of the present invention;

FIG. 8 is a perspective view of another embodiment of a cooking station, depicting the hood in the closed position, according to the present invention;

FIG. 9 is perspective view of the cooking station of FIG. 8, depicting the hood in the open position, according to another embodiment of the present invention;

FIG. 10 is an exploded perspective view of the cooking station with a griddle, depicting vents along an inner wall of a fire box of the cooking station, according to another embodiment of the present invention;

FIG. 11 is a top view of the cooking station with the griddle removed, according to another embodiment of the present invention;

FIG. 12 is a cross-sectional view of the cooking station taken along section line 5-5 in FIG. 11, according to another embodiment of the present invention;

FIG. 13 is a cross-sectional view of the cooking station taken along section line 6-6 in FIG. 11, according to another embodiment of the present invention;

FIG. 14 is an enlarged view of the cooking station taken from region C of FIG. 12, according to another embodiment of the present invention; and

FIG. 15 is an enlarged view of the cooking station taken from region D of FIG. 13, according to another embodiment of the present invention.

### DETAILED DESCRIPTION OF THE INVENTION

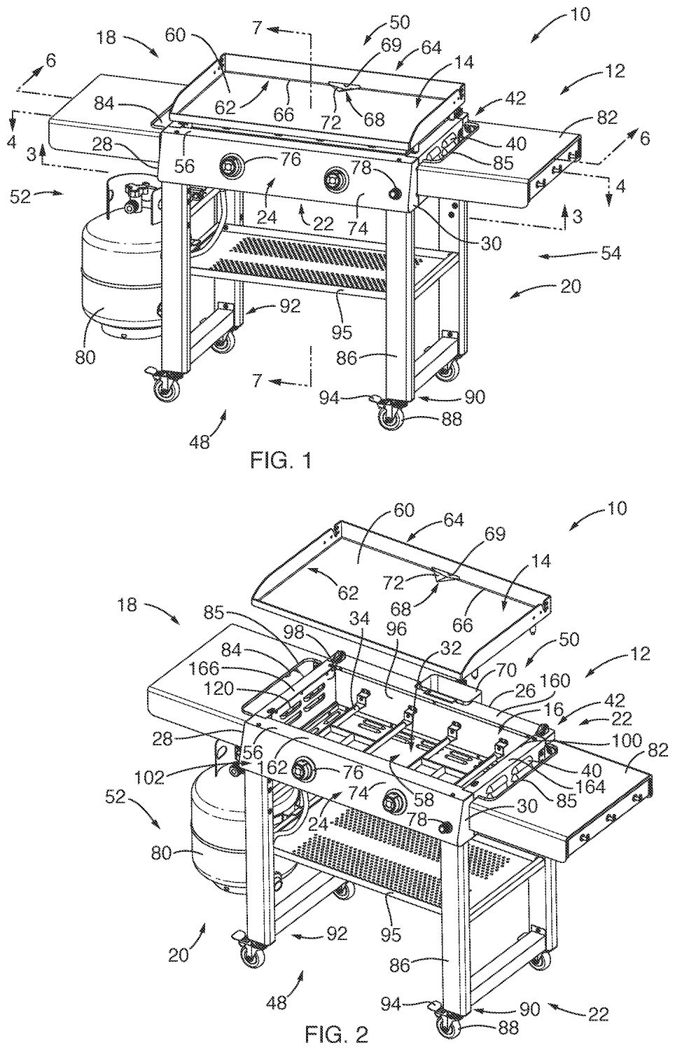

Referring to FIGS. 1, 2, 3, and 6A, a cooking system 10, which may be referenced as a cooking station 12, may be sized and configured with structure to minimize heating portions of an exterior surface of the cooking station 12. Such structure may be one or more heat shields positioned within a fire box portion or main body of the cooking station 12. In some embodiments, such heat shields may include venting for drawing air flow through the cooking station 12 to, thereby, cool certain regions or portions of the cooking station 12. In other embodiments, the venting may be in both external surfaces or panels and the heat shields for drawing air flow to interior portions of the cooking station 12.

In one embodiment, the cooking station 12 may be of the type to support a griddle 14 such that the griddle 14 may be positioned on frame structure of the cooking station 12. Such cooking station 12 may extend to define an upper portion 18 and a lower portion 20. The upper portion 18 may include a main body 22 extending to define a front panel 24, a rear panel 26, a left panel 28, and a right panel 30. The front, rear, left, and right panels 24, 26, 28, 30 may extend to define an inner portion 32 such that each of the panels may surround the inner portion 32. The inner portion 32 may contain heating elements 34 sized and configured to heat the griddle 14. Further, the inner portion 32 may include an inner wall 16 defined therein. The inner wall 16 may extend parallel to the rear, left, and right panels 26, 28, 30 such that a gap 36 may be defined therebetween. The inner wall 16 may also extend along, and be spaced relative to, the front panel 24. Further, the inner wall 16 may include inner vents 38 defined therein such the inner vents 38 may facilitate air flow therethrough. The rear, left, and right panels 26, 28, 30 may include outer vents 40 extending from the gap 36 to an exterior 42 of the cooking station 12. The gap 36 may extend to a lower end or a first end 44 where the first end 44 may include elongated openings 46 defined in, for example, a lower panel 58. The elongated openings 46 may be sized and configured to draw air into the gap 36. The inner vents 38 may be sized and configured to allow air from the gap 36 to enter the inner portion 32 of the cooking station 12 and substantially prevent radiated heat produced by the heating elements 34 from exiting the inner portion 32 into the gap 36. The outer vents 40 may be sized and configured to allow air to move from the gap 36 to exit to the exterior 42 of the cooking station 12. The elongated openings 46, inner vents 38, and outer vents 40 may be sized and configured to move air therethrough so that air may flow through the gap 36 to assist in minimizing heating certain portions, such as exterior surfaces of the cooking station 12.

Now with reference to FIGS. 1 and 2, the cooking station 12 may extend to define a front side 48, a rear side 50, a left side 52, and a right side 54. The cooking station 12 may also extend to define the upper portion 18 and lower portion 20. The upper portion 18 may include the main body 22 where the main body 22 may define the front panel 24, the rear panel 26, the left panel 28, and the right panel 30 extending to define the inner portion 32. The inner portion 32 may include heating elements 34 extending therein configured to heat the griddle 14. The front, rear, left, and right panels 24, 26, 28, 30 may extend to an upper periphery 56 and the lower panel 58. The upper periphery 56 or structure adjacent thereto may be sized and configured to support the griddle 14. In one embodiment, the griddle 14 may extend to define a flat cooking surface 60. In another embodiment, instead of a griddle, the cooking system 10 may include a grill as its cooking surface.

The cooking surface 60 of the griddle 14 may extend to define a periphery 62. The griddle 14 may include a splash guard 64 that may be coupled to the griddle 14 at the periphery 62 so as to extend along the periphery 62 of the cooking surface of the griddle 14. The splash guard 64 may be sized and configured to assist in blocking food by-product from splattering off the cooking surface 60. The cooking surface 60 may extend to a rear periphery 66 such that a trough 68 may be defined therein. The trough 68 may be positioned adjacent the rear periphery 66 of the griddle 14 and configured to direct grease and other food by-product through an opening 69 defined by the cooking surface 60 and/or the splash guard 64 to a grease container 70 positioned along the rear side 50 of the cooking station 12. Such trough 68 may include and define a sloped surface 72 configured to funnel food by-product through the opening 69 and to the grease container 70. The grease container 70 may be removably attached to the rear side 50 of the cooking station 12 or the rear panel 26 of the main body 22. Further, the grease container 70 may be positioned along the rear panel 26 of the main body 22, directly below the trough 68 of the griddle 14. Some features of the griddle 14 may be similar to that disclosed in commonly owned U.S. Pat. No. 10,327,589, filed Dec. 21, 2018, and entitled “OUTDOOR COOKING STATION WITH GRIDDLE, SYSTEM AND METHOD THEREOF,” the disclosure of which is incorporated herein by reference in its entirety.

The front panel 24 may also be a control panel 74 including manually controlled burner knobs 76 and an igniter button 78. The burner knobs 76 may be operatively coupled to the heating elements 34, such as gas burners. The burner knobs 76 may control the advancement of fuel 80 to the heating elements 34. The fuel 80 may be propane gas from a tank or natural gas employed as a fuel source to produce heat with the heating elements 34. The igniter button 78 may be coupled to the burner knobs 76, or, in another embodiment, the igniter button 78 may be positioned on the front panel 24 separate from the burner knobs 76. Further, the igniter button 78 may be configured to produce a spark to light or start the fuel 80 sent to the heating elements 34. The cooking station 12 may include and employ various structural and functional components, including alternative embodiments, as known to one of ordinary skill in the art, that may be employed with the cooking system 10 for supplying the fuel 80 to the heating elements 34 and igniting the fuel 80 at the heating elements 34.

The left and right panels 28, 30 of the main body 22 may include side shelves 82 adjacent thereto. In some embodiments, the cooking station 12 may include only one side shelf 82. The side shelves 82 may extend to define an opening 84 and ridge 85 arrangement, the opening 84 defined in one of the side shelves 82 and the ridge 85 extending along the opening 84. The opening 84 and ridge 85 arrangement may serve as a safety feature while one is cooking for assisting one from positioning objects on the shelves 82 too close to a heat zone adjacent to the griddle 14. Similar side shelves 82 are disclosed in commonly owned U.S. Pat. No. 10,779,682, filed Mar. 25, 2019, entitled “OUTDOOR COOKING STATION, SIDE SHELF, AND METHOD THEREOF,” the disclosure of which is incorporated herein by reference in its entirety.

In one embodiment, the opening 84 defined in the side shelves 82 may be positioned adjacent the outer vents 40 defined in the left and right panel 28, 30 of the main body 22. Such opening 84 may also minimize heating portions of the side shelves 82. Further, the outer vents 40 may also draw cool air from the elongated openings 46 or lower openings such that the air flow may pass through the outer vents 40 and pass by the shelves 82 to assist in minimizing heating the shelves 82.

The lower portion 20 of the main body 22 or cooking station 12 may include legs 86. The legs 86 may extend from the main body 22 or from the upper portion 18 of the cooking station 12 such that the legs 86 may extend downward to caster wheels 88 positioned on an end 90 of the legs 86. The legs 86 may be a leg set 92 pivotably coupled to the main body 22, where the leg set 92 is positioned on the left side 52 of the cooking station 12 and on the right side 54 of the cooking station 12. The caster wheels 88 may include a brake 94 configured to hold the caster wheels 88 in place when the user positions the cooking station 12 in a location for use. The main body 22 may also include a bottom shelf 95 that may extend between the leg sets 92 of the legs 86 from the left side 52 to the right side 54 of the cooking station 12. Such bottom shelf 95 may also be a support shelf.

Now with reference to FIGS. 2, 3 and 4, as previously set forth, the main body 22 may include the inner wall 16 positioned therein. Such inner wall 16 may extend parallel to the rear panel 26, left panel 28, and right panel 30. The inner wall 16 may also be spaced from and extend along the front panel 24. The inner wall 16 may be positioned so as to act as a heat shield sized and configured to block or substantially prevent heat from heating the rear panel 26, the left panel 28, and the right panel 30, as well as the front panel 24. Further, the inner wall 16 may be configured to redirect or reflect radiation heat back into the inner portion 32, described further herein. Such inner wall 16 may extend to define a rear inner wall 96, a left inner wall 98, and a right inner wall 100, as well as a front inner wall 97. The rear inner wall 96 may extend substantially parallel to the rear panel 26. The left inner wall 98 may extend substantially parallel to the left panel 28. The right inner wall 100 may extend substantially parallel to the right panel 30. The front inner wall 97 may extend parallel or be positioned and spaced to extend along the front panel 24.

The heating elements 34 may be positioned within the inner portion 32 of the main body 22 extending between the front panel 24 and the rear inner wall 96. Further, the heating elements 34 may be one or more burners in an H-burner configuration. In another embodiment, the heating elements 34 may be one or more burners in a tube or linear type configuration. The front panel 24, the rear panel 26, the left panel 28, and the right panel 30 may also be exterior panels such that the front panel 24, rear panel 26, left panel 28, and right panel 30 may define the exterior 42 of the main body 22 of the cooking station 12. The main body 22, defining the inner portion 32, may also be considered a firebox configured to contain or hold heat produced by the heating elements 34. The inner wall 16 or heat shield may be size and configured to substantially prevent the heat from overheating the exterior 42 of the cooking station 12. In other embodiments, the inner wall 16 may be configured to reflect heat or redirect the heat away from the inner wall 16 and back to a more central region within the inner portion 32.

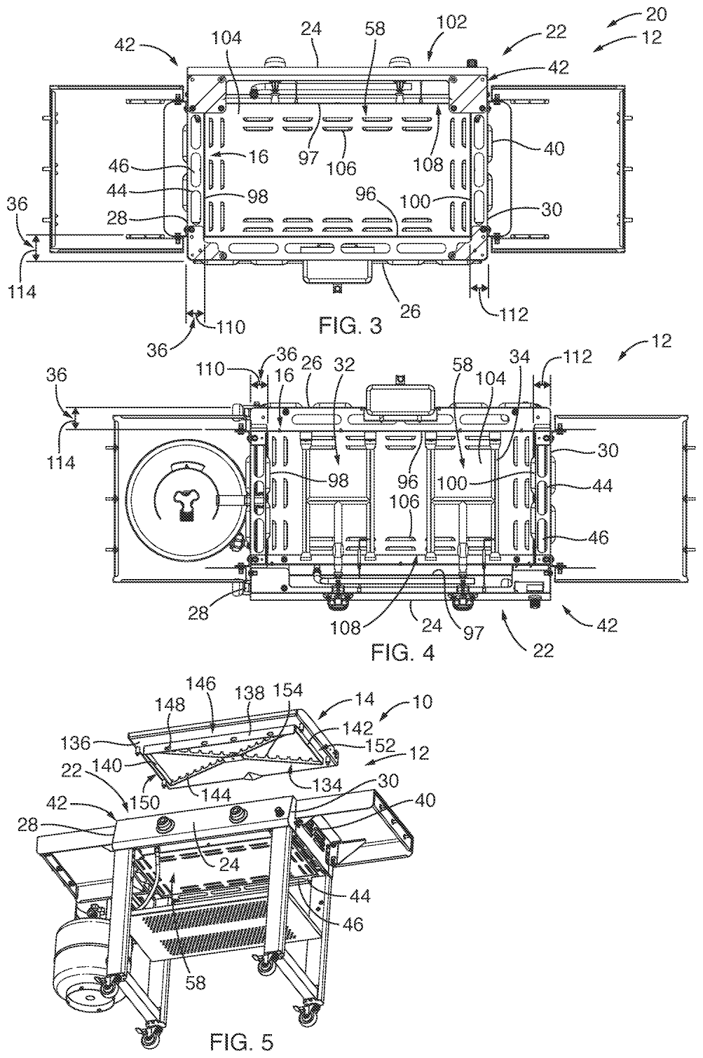

With reference to FIGS. 3 and 4, the lower panel 58 of the main body 22 may be positioned below the heating elements 34 and may extend such that the inner portion 32 or firebox may be closed off or contained by the lower panel 58 (see FIG. 5). Further, the lower panel 58 may be positioned below the heating elements 34 and extend along each of the front, rear, left, and right panels 24, 26, 28, 30 to close off or contain the heat from escaping below the heating elements 34. The lower panel 58 may extend to define a burner panel 104 and the first end 44 (or floor) of the gap 36. The burner panel 104 may be positioned directly below the heating elements 34 and extend to the front panel 24, the rear inner wall 96, the left inner wall 98, and the right inner wall 100 and may couple to the first end 44 of the gap 36. Further, the burner panel 104 may include lower vents 106 sized and configured to draw air from the exterior 42 of the cooking station 12 into the inner portion 32 to provide and feed oxygen to the heating elements 34, where the heating elements 34 may be gas burning flame burners. The lower vents 106 may be positioned along a perimeter 108 of the burner panel 104 and may extend from the exterior 42 of the cooking station 12 into the inner portion 32 of the main body 22. In another embodiment, the burner panel 104 may define vents directly adjacent the burners to feed oxygen thereto.

As previously set forth, the first end 44 or the floor end of the gap 36 may also be included as a portion of the lower panel 58. The first end 44 may extend partially along the perimeter 108 of the burner panel 104 such that the first end may extend along the rear inner wall 96, the left inner wall 98, and the right inner wall 100. Further, the first end 44 may be coupled to the burner panel 104 and the inner wall 16. The first end 44 may extend from the inner wall 16 to the rear panel 26, the left panel 28, and the right panel 30. Even further, the first end 44 may include the elongated openings 46 defined therein extending along the first end 44. Such first end 44 may define multiple elongated openings 46 along each respective length of (and along) the rear, left and right panels 26, 28, 30. The elongated openings 46 may extend from the exterior 42 of the cooking station 12 and into the gap 36. Further, the elongated openings 46 may be sized and configured to draw air flow from the exterior 42 of the cooking station 12 into the gap 36 to cool the inner wall 16, the gap 36, and each of the respective rear, left and right panels 26, 28, 30.

As previously set forth, the inner wall 16 may include components that extend parallel to each of the rear, left and right panels 26, 28, 30 such that the gap 36 may be defined between the inner wall 16 and each of rear, left and right panels 26, 28, 30. In one embodiment, the gap 36 may extend continuously between the inner wall 16 and each of the rear panel 26, the left panel 28, and the right panel 30. In another embodiment, the gap 36 may not extend continuously such that the gap 36 may be obstructed by structural components of the main body 22 or the inner wall 16 or components extending from the inner wall 16. For example, the gap 36 may extend between the left inner wall 98 and the left panel 28 to define a left gap 110 such that the left gap may extend to a rear inner wall 96, where the rear inner wall 96 may be coupled to the left inner wall 98 and the left panel 28. Further, a right gap 112 may be defined extending between the right inner wall 100 and the right panel 30, and a rear gap 114 may be defined extending between the rear inner wall 96 and the rear panel 26. The gap 36 may be configured to be an air buffer such that radiated heat may be prevented from warming or overheating the exterior 42 of the cooking station 12 or overheating the rear panel 26, the left panel 28, and the right panel 30 of the main body 22. Further, the gap 36 and the inner wall 16 may be configured to provide further structural support to the main body 22 such that the main body 22 may be reinforced as extreme thermal fatigue occurs through the continuing iterative use of the cooking station 12.

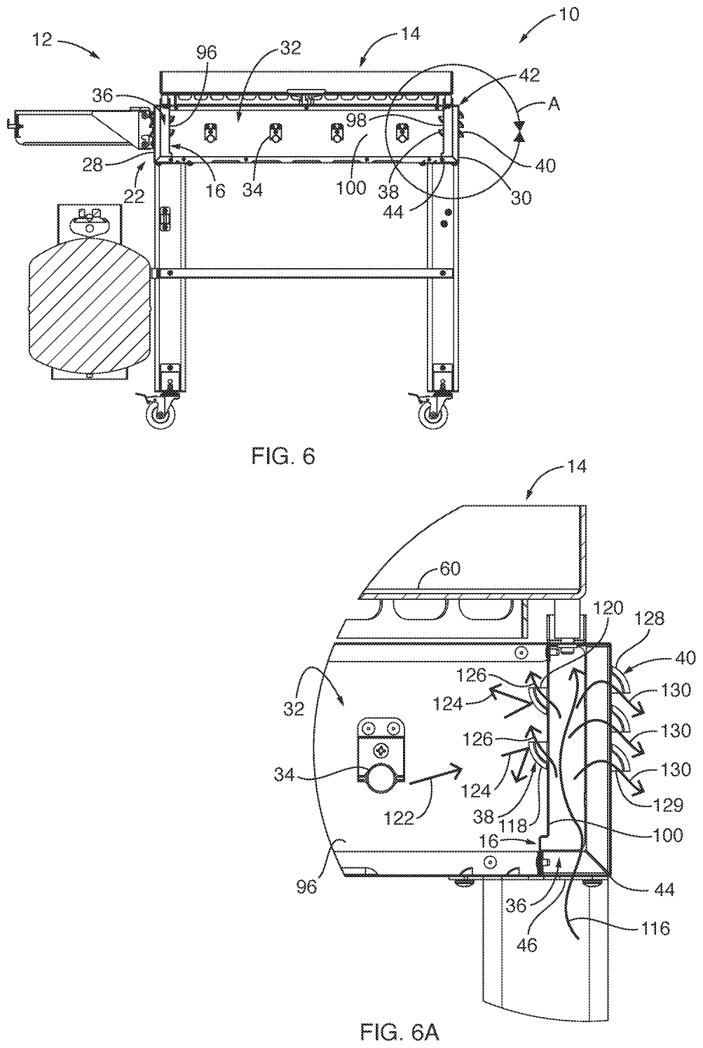

With reference to FIGS. 5, 6, and 6A, the first end 44 or floor of the gap 36 may include the elongated openings 46 configured to draw cool air into the gap 36 from the exterior 42 of the cooking station 12, as shown by arrow 116. The air may be drawn into the gap 36 to minimize heating the rear panel 26 (FIG. 2), left panel 28, and right panel 30 while the cooking station 12 is in use. The inner wall 16 may include inner vents 38 defined therein, the inner vents 38 extending between the gap 36 and the inner portion 32 of the main body 22 to facilitate air flow therethrough. In one embodiment, the inner vents 38 may be defined on the rear inner wall 96, the left inner wall 98, and the right inner wall 100. In another embodiment, the inner vents 38 may be defined on the left inner wall 98 and the right inner wall 100. The inner vents 38 may include an inner vent blocking structure 118. The inner vent blocking structure 118 may extend partially over the airway of the inner vents 38. Further, the inner vent blocking structure 118 may extend over the inner vents 38 with a vent opening 120 facing upward so that the vent opening 120 of the inner vents 38 may be partially or fully obscured relative to the level of the heating elements 34. In this manner, the inner vent blocking structure 118 may extend to block direct line of sight or a direct line from the gas flame of the heating elements 34 to the vent opening 120 so that the vent opening 120 may be obscured from the radiating heat of the heating elements 34. The heating elements 34 may radiate heat or radiate energy, where the radiated heat may extend in direct lines outward from the heating elements 34, as shown by arrow 122. The inner vent blocking structure 118 of the inner vents 38 may be configured to block the direct line of radiated heat from entering the gap 36 through the vent opening 120 of the inner vents 38 such that the radiation energy may redirect the direct line of radiated heat back towards the inner portion 32 of the main body 22, as shown by arrows 124. Further, the inner vents 38 may facilitate air being drawn therethrough from the gap 36 and into the inner portion 32 of the main body 22, as shown by arrows 126.

As previously set forth, each of the rear panel 26 (FIG. 2), the left panel 28, and the right panel 30 may include the outer vents 40 defined therein. Such outer vents 40 may facilitate cool air being drawn from the lower openings 46, through the gap 36 and to the exterior 42 of the cooking station 12. The outer vents 40 may define an outer vent blocking structure 128 with a vent opening 129 that may face downward such that the vent opening 129 may be at least partially obscured by the outer vent blocking structure 128. Further the outer vent blocking structure 128 may extend in other configurations where the vent opening 120 may be at least partially obscured. Even further, the outer vent blocking structure 128 may be extend and be configured to at least partially prevent the vent opening 129 from being exposed to rain or other external debris from entering the gap 36 through the outer vents 40. As previously set forth, the elongated openings 46 defined in the floor of the gap 36 may allow for cool air flow therethrough to enter the gap 36, as shown by arrow 116, and to be drawn through the outer vents 40, as shown by arrow 130, so that the air within the gap 36 may cool or minimize heating of the exterior 42, namely, rear, left and right panels 26, 28, 30 of the main body 22.

In the configuration described above, the elongated openings 46 defined in the floor or first end 44 of the gap 36 may facilitate drawing air flow into the gap 36, as shown by arrow 116. The air flow may push air out of the gap 36 through the inner vents 38 directing the air into the inner portion 32, as shown by arrow 126. Further, the inner vent blocking structure 118 of the inner vents 38 may block direct “line of sight” radiation energy from the heating elements 34 through the inner vents 38 so that the radiation energy deflects or may be absorbed by the inner vent blocking structure. Also, the elongated openings 46 defined in the floor may facilitate drawing air therethrough and into the gap 36 and further, for air to be drawn through the outer vents 40, as shown by arrow 130, to the exterior 42 of cooking station 12 such that the air may be directed away from the cooking station 12.

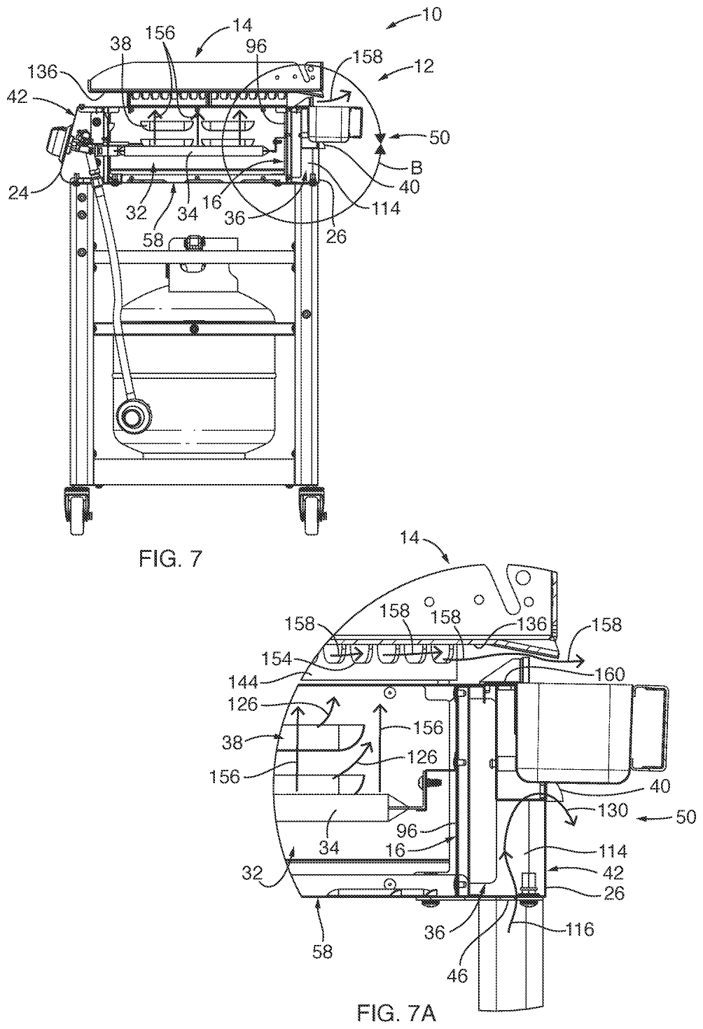

Now with reference to FIGS. 5, 7, and 7A, the griddle 14 may include an understructure 134 sized and configured to support, reinforce, and brace an underside 136 of the griddle 14 from temperature variations across various portions of the griddle 14 so as to assist in substantially preventing the griddle from warping and/or undergoing the effects of thermal fatigue. Such understructure 134 may include similar structure and function similar to the understructure and griddle disclosed in commonly owned U.S. patent application Ser. No. 17/725,630, filed on Apr. 21, 2022, entitled “COOKING STATION AND GRIDDLE WITH UNDERSTRUCTURE AND METHOD THEREOF,” the disclosure of which is incorporated by reference herein in its entirety.

The understructure 134 may include a front structure 138, a left structure 140, a right structure 142, and diagonal structures 144. The front structure 138 may be positioned on a front underside 146 of the griddle 14 and may extend along a length of the front underside 146 of the griddle 14. Further, the front structure 138 may include openings 148 sized and configured to allow the user to view the heating elements 34, and, more specifically the openings 148 may allow for the user to view the flame of the heating elements 34, such as gas flame burners. The left structure 140 may be positioned on a left underside 150 of the griddle 14 and may extend along a length of the left underside 150 of the griddle 14. The right structure 142 may be positioned on a right underside 152 of the griddle 14 and may extend along a length of the right underside 152 of the griddle 14. The diagonal structures 144 may be positioned on opposite sides of the left underside 150 of the griddle 14, where, the diagonal structures 144 may extend diagonally (or transverse relative to each of the front structure 138, left structure 140, and right structure 142) across the underside 136 of the griddle 14 to opposite sides of the right underside 152 of the griddle 14 (so that the diagonal structures 144 extend with an x-configuration). Further, the diagonal structures 144 may extend to include openings 154 extending through the diagonal structures 144 along the length of the diagonal structures 144. The openings 154 may be sized and configured to allow for heat to move from the inner portion 32, to the underside of the griddle 14 (see arrows 156), and then to be directed toward the rear side 50 of the cooking station 12, as shown by arrow 158, so as to exit the underside of the griddle 14 along a single side or rear side of the griddle 14.

With reference to FIGS. 2, 5, 6A, and 7A, as previously set forth, the elongated openings 46 defined in the floor of the gap 36 may facilitate air flow to move through the gap 36, as shown by arrow 116, to cool the rear panel 36, the left panel 28, and the right panel 30. The rear panel 26 may also include the outer vents 40 which may be sized and configured to direct air from the gap 36 to an exterior 42 of the cooking station 12 as shown by arrow 130. In this configuration, air flow may move through the rear gap 114 to assist in cooling the rear panel 26 of the main body 22. Although not shown in this embodiment, the rear inner wall 96 may also include the inner vents 38 (similar to the left and right inner walls 98, 100), which may include the inner vent blocking structure to block the direct line of radiation from the heating elements 34 from passing through the vent opening of the inner vent in the rear inner wall, similar to that described for the left and right inner walls 98, 100. With this arrangement, the front, left and right structures 138, 140, 142 of the understructure 134 (as well as the diagonal structures 144) may hold heat moving upward, as shown by arrow 156, from the heating elements 34 to the underside of the griddle 14 so that the openings 148 defined in the diagonal structures 144 may then facilitate the heat to be channeled rearward, as shown by arrow 158, so that at least the majority of the heat is funneled and exits the cooking station 12 between the rear underside of the griddle 14 and a rear upper side 160 of the main body 22. As such, the front structure 138 of the understructure 134 may be positioned adjacent to a front upper side 162 of the main body 22, the left structure 140 of the understructure 134 may be positioned adjacent a left upper side 164 of the main body 22, and the right structure of the understructure 134 may be positioned adjacent a right upper side 166 of the main body 22, to assist the heat in being funneled rearward from the griddle 14. Since the heat moving upward, as shown by arrow 156, from the heating elements 34 may substantially escape the cooking station from a single side of the griddle 14, as shown by arrow 158 (due to the front, left and right structures 138, 140, 142 of the griddle 14 being positioned adjacent to the respective front, right and left upper sides 162, 164, 166 of the main body 22) the resulting temperatures of portions of the main body 22 may be susceptible to increased temperatures. Furthermore, the airflow moving along the underside of the griddle 14 and exiting along a single side of the griddle 14, as depicted by arrow 158, may facilitate an increased draw of airflow through the lower openings 46 and into the gap 36 and then through the inner vents 38 and/or outer vents 40 of the main body 22, thereby, minimizing the heating of the external surface of portions of the main body 22. As such, the inner wall 16 or heat shield positioned within the inner portion 32 may be advantageous to protect various components of the main body 22 as well as keeping the exterior wall of the main body 22 cooler so it is less likely to cause damage to surrounding objects and from a person becoming burned by accidentally touching such exterior wall while the cooking station 12 may be generating heat.

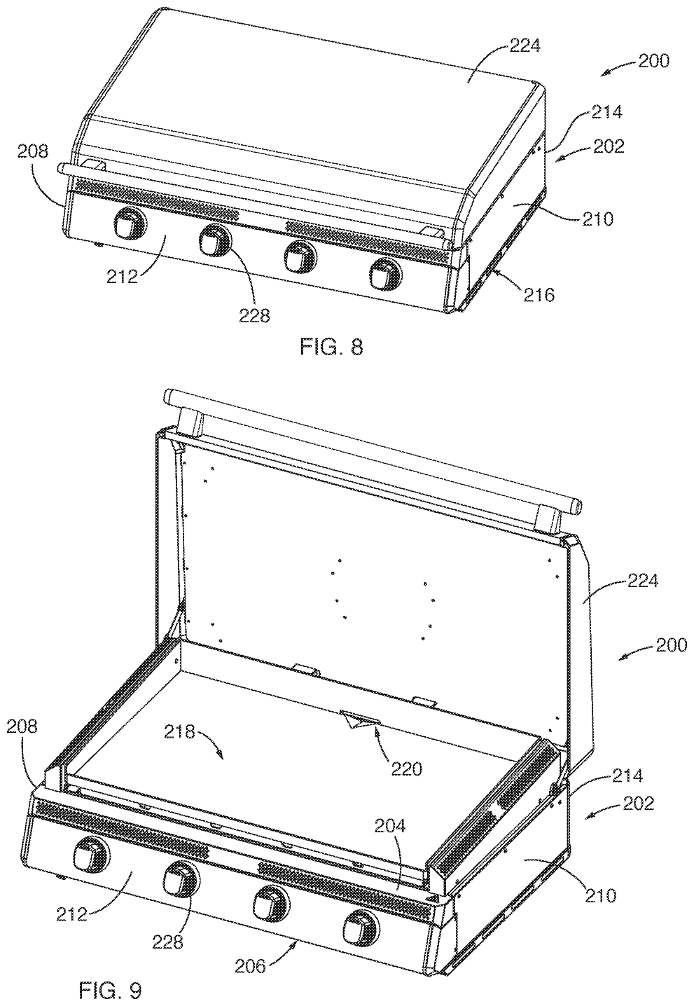

Now with reference to FIGS. 8-11, another embodiment of a cooking station 200 having two peripheral walls that define a gap therebetween and venting in the walls is provided. The cooking station 200 of this embodiment may be an insert type cooking station for inserting within a prepared space within a countertop or the like. The cooking station 200 may include a main body 202 with various panels and frame components. For example, the main body 202 may extend between an upper end 204 or upper side and a lower end 206 or lower portion. Further, the main body 202 may extend to define a first panel 208, a second panel 210, a front panel 212, and a rear panel 214, the first and second panels 208, 210 extending generally parallel to each other. The rear panel 214 may extend generally perpendicular to the first and second panels 208, 210. The front panel 212 may extend parallel to the rear panel 214, or the front panel 212 may be oriented at an angle so that the upper and lower ends of the front panel 212 extend parallel relative to the rear panel 214. The lower end 206 of the main body 202 may include a lower panel 216 extending to each of the first, second, front and rear panels 208, 210, 212, 214.

The main body 202 may be sized and configured to support a griddle 218 such that the griddle 218 may be positioned above the upper end 204 of the main body 202. As in the previous embodiment, the griddle 218 may include an opening 220 defined therein that may be positioned to drain grease therethrough so that the grease, generated from cooking food, may be funneled into a grease cup 222. Such grease cup 222 may be positioned adjacently along a rear underside of the griddle 218. Further, the main body 202 may include a hood 224 that may be pivotably coupled to the main body 202 or operably coupled to the griddle 218 such that the hood 224 may be moved between a closed position and an open position. The closed position of the hood 224 may be configured to cover the griddle 218. The open position of the hood 224, being pivotably coupled to portions of the main body 202, may be configured to be moved to a pivoted position and an upright position, relative to the closed position. Furthermore, the griddle 218 may include an understructure 219 along an underside of the griddle 218, similar to that depicted in FIG. 5, and as such, the understructure 219 of the griddle 218 may be sized and configured to funnel the heat from burners rearward along the underside of the griddle 218.

The main body 202 may also include multiple burners 226, such as four burners in this embodiment, that may be supported by panels or frame components of the main body 202 so as to extend between front and rear sides of the main body 202. The burners 226 may be associated with burner knobs 228 such that each burner 226 may correspond with one of the burner knobs 228. The burners 226 and burner knobs 226 may be sized and configured to be coupled to a gas supply, such as a tank or to a direct gas line for feeding propane or natural gas toward the burners 226, the burners 226 and burner knobs 228 being associated with various tubing, valves and other functional and structural components or the like to facilitate controlling and supplying gas through the burners 226, as known to one of ordinary skill in the art.

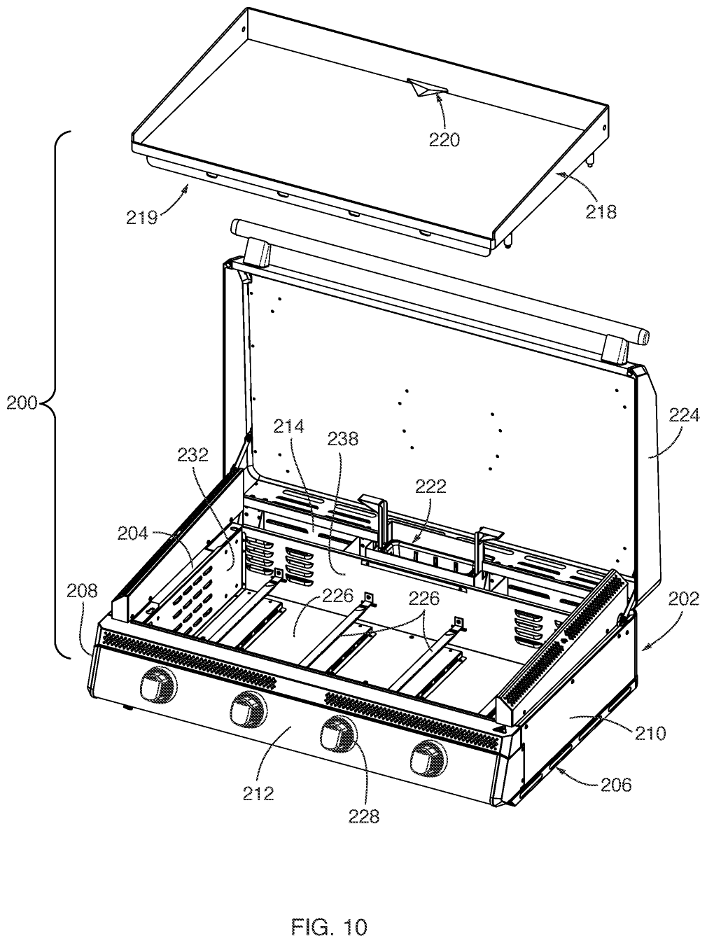

With reference to FIGS. 10, 11, 12 and 13, the main body 202 (which may also be referenced as a fire box) may include inner walls 230 that may each act as a heat shield. For example, the inner walls 230 may include a first inner wall 232, a second inner wall 234, a front inner wall 236 and a rear inner wall 238 each of which may extend generally parallel and/or correspond with the respective first panel 208, second panel 210, front panel 212 and rear panel 214. Each of the first inner wall 232, second inner wall 234, rear inner wall 236 and the front inner wall 238 may extend directly from, and generally perpendicular to, the lower panel 216 to about a height of each of the first panel 208, second panel 210, front panel 212 and the rear panel 214, respectively.

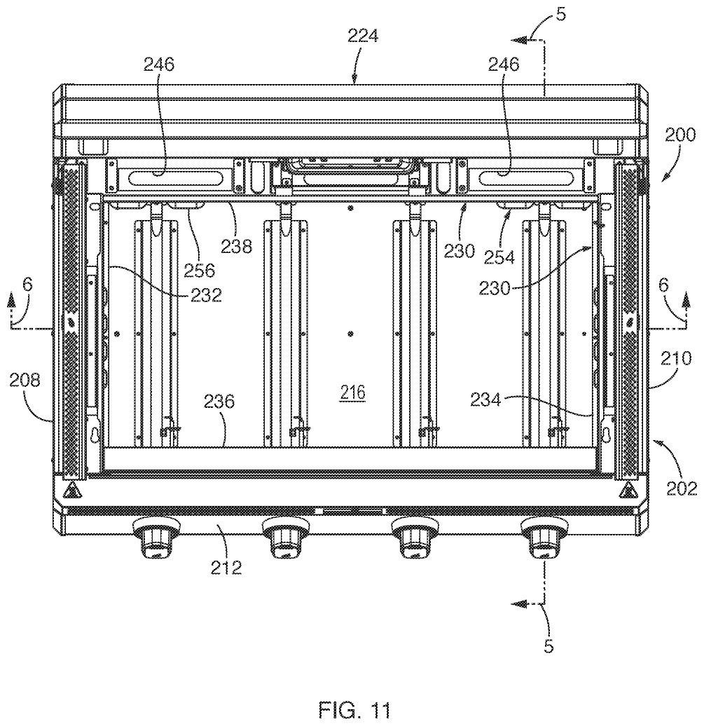

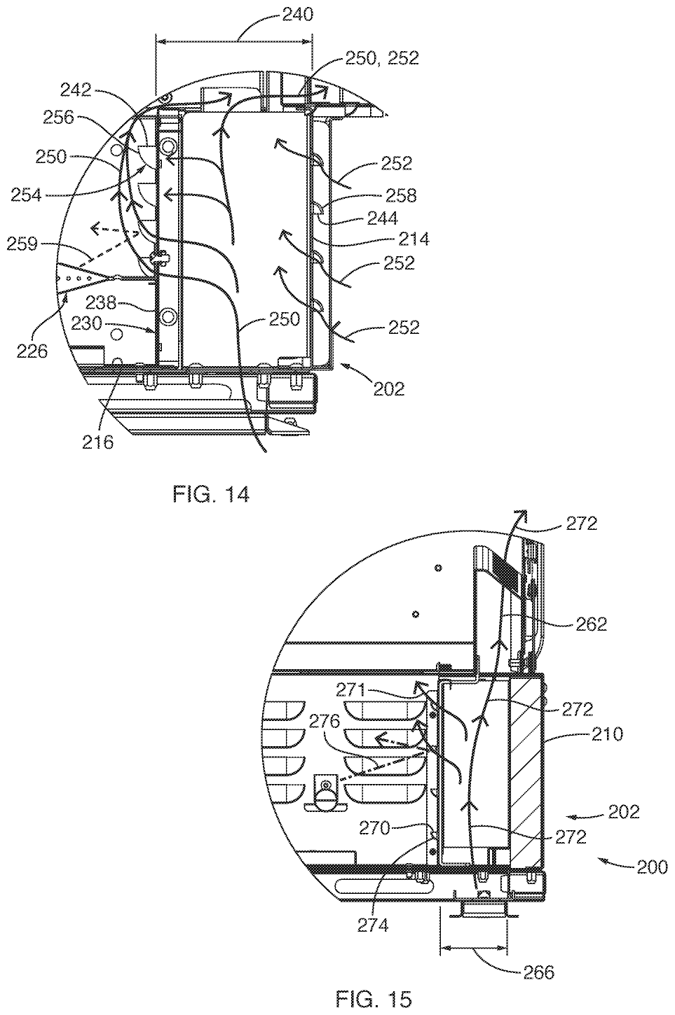

Now with reference to FIGS. 11, 12 and 14, the rear inner wall 238 and the rear panel 214 may define a rear gap 240 therebetween. The rear inner wall 238 may include rear inner vents 242 defined therein and the rear panel 214 may include rear outer vents 244 defined therein. The rear inner vents 242 may be defined in rows and columns along the rear inner wall 238. In one embodiment, the rear inner wall 238 may extend on one side of the grease cup 222 (FIG. 10) and act as a heat shield to the grease cup 222 such that the rear inner wall 238 may not include rear inner vents 242 along the rear inner wall 238 where the grease cup 222 may be positioned. Similar to the vents of the rear inner wall 238, the rear panel 214 may include rows and columns of the rear outer vents 244 defined in the rear panel 214. Such rear inner vents 242 and rear outer vents 244 defined in the rear inner wall 238 and rear panel 214, respectively, may be sized and configured to draw cool air upward through rear lower openings 246 (FIG. 11) defined in the lower panel 216 or adjacent the lower panel 216. The drawn cool air may move and flow from the rear lower openings 246 and into the rear gap 240 and through the rear inner vents 242, to be drawn upward and along the rear underside of the griddle 218 (FIG. 10) and upward and along an inner side of the hood 224, as depicted by primary rear air flow arrow 250. Further, a secondary air flow 252 may move into the gap 240 from the rear outer vents to flow upward to meet with the primary rear air flow 250. In another embodiment, the rear inner vents 242 may each include a hood structure 254, such as an upward extending hood 256. The rear outer vents 244 may also include a hood structure 254 that may include a downward extending hood 258. As in the previous embodiment, the hood structure 254 of the rear inner vents may act to block radiation heat directed from the burners 226 toward the rear inner vents 242 such that the radiation heat may be reflected from the hood structure 254 of the rear inner vents 242, as depicted by arrow 259, similar to the previous embodiment. With this arrangement, the rear inner vents 242 may direct air flow, as depicted by arrow 250, from the rear lower openings 246 for cooling the rear inner wall 238 and, in some embodiments, the rear inner vents 242 may include hood structure 254 to minimize radiation heat entering the rear gap 240 through the rear inner vents 242.

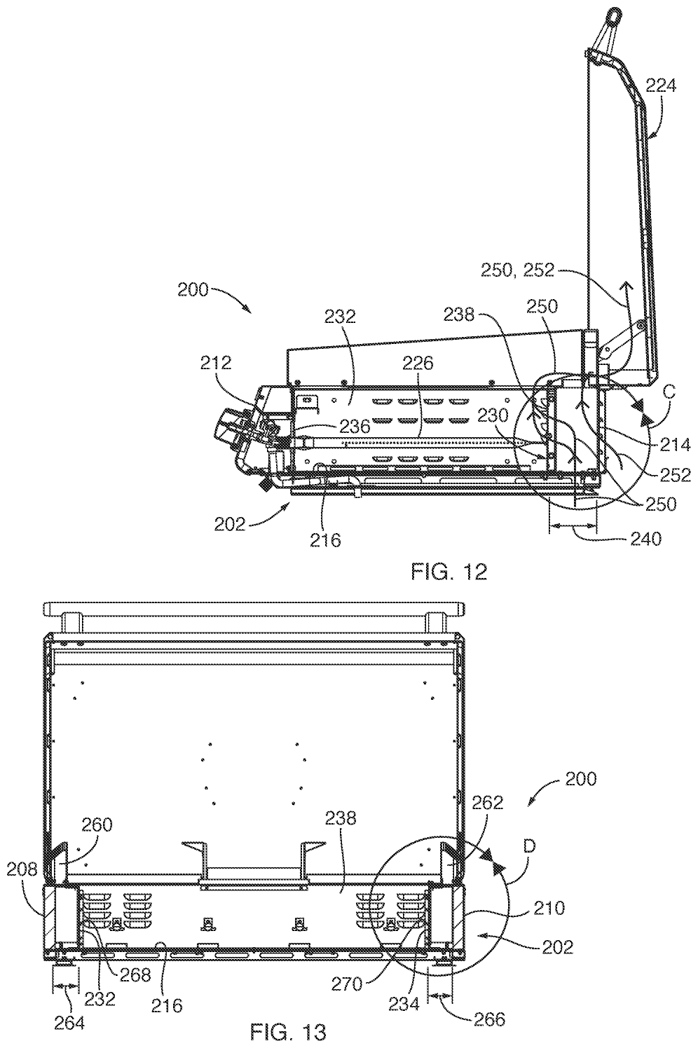

With reference to FIGS. 11, 13 and 15, the main body 202 of the cooking station 200 may include first and second vent ducts 260, 262 for channeling heat from the underside of the griddle 218. Similar first and second vent ducts 260, 262 are disclosed in commonly owned U.S. patent application Ser. No. 16/926,681, filed Jul. 11, 2020, entitled “HEAT CHANNELING SYSTEMS FOR OUTDOOR COOKING STATION AND METHOD THEREOF,” the disclosure of which is incorporated by reference herein in its entirety. The first and second inner walls 232, 234 may be spaced and extend parallel with the first and second panels 208, 210, respectively, to define respective first and second gaps 264, 266 therebetween. As such, the first and second gaps 264, 266 may extend along left and right sides of the main body 202. The first inner wall 232 (see also, FIG. 10) and the second inner wall 234 may define first and second inner vents 268, 270 therein. Such first and second inner walls 232, 234 may extend and act as a heat shield. Further, the most of the air flow from under the griddle 218 (FIG. 10) may be funneled rearward, which may draw air flow from the first and second gaps 264, 266 and through the first and second inner vents 268, 270 to the underside of the griddle 218, as shown by arrow 271. Further, the heated air funneled rearward from the griddle 218 may draw cool air upward from lower openings (not shown) at the bottom of the first and second gaps 264, 266, to be drawn through the first and second gaps 264, 266 and through the first and second vent ducts 260, 262 to exit from apertures defined along an upper side of the first and second vent ducts 260, 262, as depicted by air flow arrow 272. In this manner, the cool air drawn upward, as depicted in arrow 272, may facilitate minimizing the heating of the first and second panels 208, 210 of the main body 202. In another embodiment, the first and second inner vents 268, 270 may each include a hood structure 274 that may block radiation heat from the burners 226 from entering the first and second gaps 264, 266, and reflect the radiation heat from entering the first and second gaps 264, 266, as depicted by directional arrow 276, similar to that previously described. As depicted in the embodiments herein, the understructure 219 of the griddle 218 (see also, FIG. 10) may be configured to move heated air to flow rearward, which may draw air flow from the respective first and second gaps 264, 266 and through the respective first and second inner vents 268, 270 of the first and second inner walls 232, 234, as well as the rear inner wall 238, to draw cool air into the respective first and second gaps 264, 266 and the rear gap 240 (FIG. 12) and minimize heating of portions of the main body 202 or rather, minimize heating of the exterior walls or panels of the main body 202. Furthermore, the inner walls 230 may act as heat shields to exterior walls or panels. Also, the hood structure 274 extending over the vent openings defined in the inner walls 230 may substantially direct and reflect radiation heat from entering the first and second gaps 264, 266, as well as the rear gap 240, and thus minimize heating of the exterior walls, but still direct air flow and minimize the heating of portions of the main body 202, as described herein.

The various structural components of the embodiments of the cooking system set forth herein may be formed from metallic materials, such as stainless steel, steel or aluminum, or any other suitable metallic material, as well as any other materials needed to form and manufacture the various components of the cooking system, as known by one of ordinary skill in the art. Further, the components of the cooking system may be formed by employing known manufacturing techniques and processes, such as welding, molding, milling, drilling, bending, fastening, soldering, etc., as known to one of ordinary skill in the art.

While the invention may be susceptible to various modifications and alternative forms, specific embodiments have been shown by way of example in the drawings and have been described in detail herein. Further, the structural features of any one embodiment disclosed herein may be combined or replaced by any one of the structural features of another embodiment set forth herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A cooking system configured to minimize heating portions of the cooking system, comprising:
a cooking station extending to define a front panel, a rear panel, a left panel, and a right panel, the front panel, the rear panel, the left panel, and the right panel extending to define an inner portion of the cooking station, the inner portion configured to hold heating elements sized and configured to heat a griddle associated with the cooking station;
an inner wall positioned within the inner portion of the cooking station and extending parallel to the rear panel, the left panel, and the right panel of the cooking station, the inner wall including inner vents defined therein, the rear panel, the left panel, and the right panel including outer vents defined therein; and
a gap defined between the inner wall and each of the rear panel, the left panel, and the right panel, the gap having a floor panel, the floor panel including elongated openings defined therein, the elongated openings sized and configured to draw air into the gap and through the inner vents extending from the gap into the inner portion of the cooking station, and to draw air into the gap and through the outer vents extending from the gap to an exterior of the cooking station.

2. The cooking system of claim 1, wherein the inner wall and the gap are sized and configured to minimize heating of the rear panel, the left panel, and the right panel.

3. The cooking system of claim 1, wherein the inner vents include inner vent blocking structure positioned to block direct line radiation heat of the heating elements from passing through a vent opening of the inner vents.

4. The cooking system of claim 3, wherein the vent opening of the inner vent blocking structure extends upward.

5. The cooking system of claim 1, wherein the outer vents include outer vent blocking structure positioned to block moisture from moving therethrough such that the outer vent blocking structure extends downward.

6. The cooking system of claim 1, wherein the cooking station includes a lower panel positioned below the heating elements, the lower panel having vents defined therein, the vents positioned to draw air into the inner portion of the cooking station to feed oxygen to the heating elements.

7. The cooking system of claim 1, wherein, upon heating the griddle, heat moves along an underside of the griddle to facilitate drawing air to flow through the openings, through the gap, and through the inner and outer vents.

8. The cooking system of claim 1, wherein, upon the griddle being positioned on the cooking station and being heated by the cooking station, heat funnels substantially to a single side of the griddle and from the cooking station.

9. A cooking station configured to minimize heating portions of the cooking station, the cooking station comprising:
a main body with a front panel, a rear panel, a left panel and a right panel each extending to define an inner portion, the inner portion configured to hold heating elements positioned therein, and the rear panel, the left panel and the right panel each defining outer vents therein;
a heat shield positioned within the inner portion of the main body, the heat shield extending with a rear heat shield, a left heat shield, and a right heat shield each positioned to be substantially parallel with the rear panel, the left panel and the right panel, respectively, so as to define a gap therebetween, the gap defining a floor panel with floor vents defined therein; and
a griddle configured to be positioned over the heating elements and supported by the main body;
wherein, upon the griddle being heated by the heating elements, air is drawn through the floor vents into the gap and flows through the outer vents defined in each of the rear panel, the left panel and the right panel.

10. The cooking station of claim 9, wherein the heat shield includes inner vents defined therein, the inner vents configured to facilitate air flow therethrough from the gap to the inner portion of the main body with the heating elements.

11. The cooking station of claim 10, wherein the inner vents comprise inner vent blocking structure positioned to block direct line radiation heat of the heating elements from passing through a vent opening of the inner vents.

12. The cooking station of claim 11, wherein the inner vent blocking structure extends upward.

13. The cooking station of claim 9, wherein the outer vents include outer vent blocking structure positioned to block moisture from moving therethrough such that the outer vent blocking structure extends downward.

14. The cooking station of claim 9, wherein the heat shield and the gap are sized and configured to minimize heating of the rear panel, the left panel and the right panel.

15. The cooking station of claim 9, wherein the floor panel extends between each of the front panel, the rear panel, the left panel and the right panel so as to extend below each of the heating elements and at least partially define the gap, the floor panel including vent structure positioned below the heating elements and configured to draw air toward the heating elements to feed oxygen to the heating elements.

16. A method for minimizing heat in a cooking system, comprising:
providing a main body of a cooking station with a front panel, a rear panel, a left panel and a right panel each extending to surround an inner portion of the main body, the inner portion containing heating elements positioned therein, and the rear panel, the left panel, and the right panel each defining outer vents therein, the main body including a heat shield positioned within the inner portion of the main body, the heat shield extending with a rear heat shield, a left heat shield, and a right heat shield each positioned to be substantially parallel with the rear panel, the left panel and the right panel, respectively, so as to define a gap therebetween, the gap defining a floor panel with floor vents defined therein;
heating a griddle positioned on the main body above the heating elements; and
drawing air through the floor vents into the gap to flow through the outer vents defined in each of the rear panel, the left panel and the right panel so as to minimize a temperature of portions of an exterior surface of the main body.

17. The method according to claim 16, wherein the drawing comprises moving air from the gap and through inner vents defined in the heat shield to move air into the inner portion with the heating elements.

18. The method according to claim 17, further comprising blocking direct line radiation heat from the heating elements with inner vent blocking structure from passing through a vent opening of the inner vents.

19. The method according to claim 17, wherein the heating the griddle comprises substantially funneling most of the heat toward and from a single side of the griddle and main body of the cooking station.
